(19) United States
(12) Patent Application Publication
(10) Pub. No.: US 2020/0089795 A1
(43) Pub. Date: Mar. 19, 2020

(54) DATASET ORCHESTRATION WITH METADATA VARIANCE DATA

(71) Applicant: Hewlett-Packard Development Company, L.P., Houston, TX (US)

(72) Inventors: Kevin WILLIAMS, San Diego, CA (US); Amit Kumar SINGH, Houston, TX (US)

(21) Appl. No.: 16/133,040

(22) Filed: Sep. 17, 2018

(51) Int. Cl. G06F 17/30

(52) U.S. Cl. CPC G06F 17/30392; G06F 17/30498; G06F 17/30997; G06F 17/30946

(57) ABSTRACT

An example of an apparatus including a network interface to receive a first dataset and a second dataset. The first dataset includes first metadata and the second dataset includes second metadata. The apparatus further includes a processor to determine a variance value associated with the first metadata and the second metadata. The apparatus also includes an orchestration engine to use the variance value to orchestrate data between the first dataset and the second dataset.

### BACKGROUND

Data may be stored in computer-readable databases. These databases may store large volumes of data collected over time. Processing large databases may be inefficient and expensive. Computers may be used to retrieve and process the data stored in databases.

### BRIEF DESCRIPTION OF THE DRAWINGS

Reference will now be made, by way of example only, to the accompanying drawings in which:

FIG. 1 is a block diagram of an example apparatus to orchestrate data with metadata variance data;

FIG. 2 is a flowchart of an example of a method of orchestrating data with metadata variance data;

FIG. 3 is a flowchart of another example of a method showing the execution of a portion of the method of FIG. 2 in greater detail;

FIG. 4 is a block diagram of an example system to orchestrate data from multiple sources with metadata variance data;

FIGS. 5A-B are examples of a metadata tables generated from the datasets from (a) a first dataset source and (b) a second dataset source; and

FIGS. 6A-B are examples of a joined metadata tables showing the percentage variance calculated from (a) a first dataset source and (b) a second dataset source.

### DETAILED DESCRIPTION

Increasing volumes of data create increased complexity when storing, manipulating, and assessing the data. For example, with increases in the connectively of devices and the number of sensors in the various components of each device making time-series measurements, the generated data is increasingly voluminous and complex.

Complexity in retrieving, combining, migrating, and manipulating multiple datasets may arise from the complex data structures of systems, system components, and component attributes and their corresponding values. In addition, such complexity may arise from the large volumes of data generated by lengthy time-series measurements related to ensembles of numerous systems. Accordingly, multiple databases of lookup datasets (each dataset corresponding to a separate system) may be joined and presented at a single location instead of spread across multiple sources. It is to be appreciated that combining large datasets may present problems if the metadata from the datasets are not identical, such if the datasets are received from multiple sources having different designs.

As an example, an organization may migrate data from one dataset to another or combine multiple datasets during a hardware upgrade or modernization of its infrastructure. It is to be appreciated that each dataset may vary due to differences in design and implementation. Accordingly, once the data in each dataset is migrated or moved, the data may be tested to ensure the data in the new database is correct to reduce potential errors being introduced during the process. The data may be tested using testing code or by sampling data from the datasets; however, this may not be practical as the datasets become larger and/or more complex.

As described herein, a database may store metadata from multiple dataset sources along with variance values to facilitate testing of multiple datasets. The metadata from the different sources may be stored in a single structure with a substructure to store variance values. This provides the capability to automatically generate variance reports using automated processes, referred to as database orchestration. Therefore, large and complex databases may be migrated and tested in an efficient manner. In particular, the variance values stored provide a quick and efficient method to quantify how different metadata (i.e. a dataset structure) is from one data source to another. This may allow an administrator to validate the data sources and to identify potential design issues that may need to be addressed based on a quantified difference between multiple data sources.

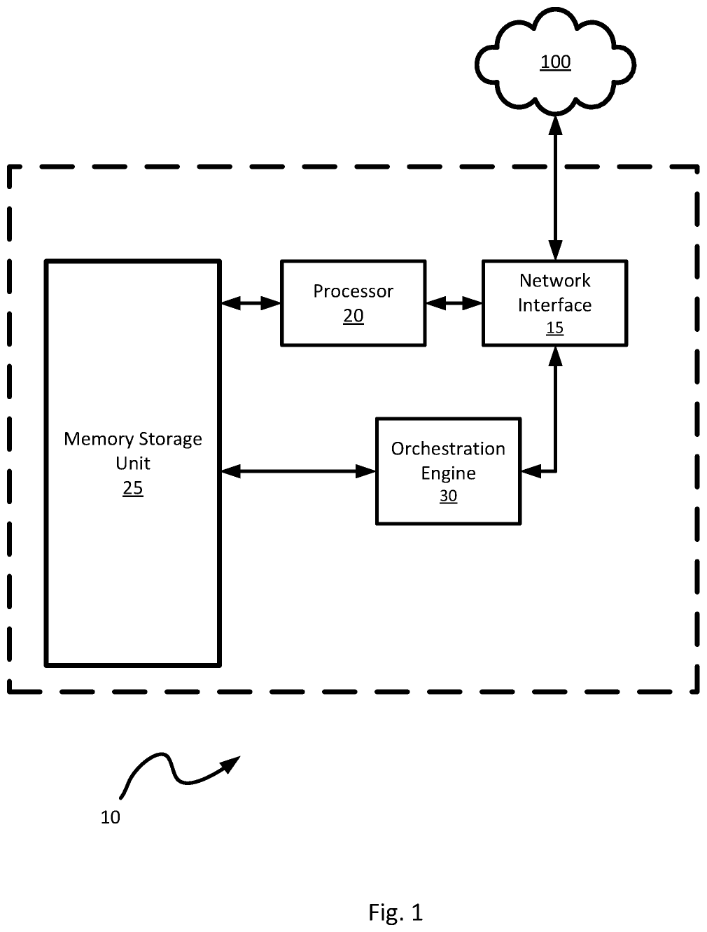

Referring to FIG. 1, an apparatus to orchestrate data with metadata variance data is generally shown at 10. The apparatus may include additional components, such as various memory storage units, interfaces to communicate with other computer apparatus or devices, and further input and output devices to interact with a user or another device. In the present example, the apparatus 10 includes a network interface 15, a processor 20, a memory storage unit 25, and an orchestration engine 30. Although the present example shows the processor 20 and the orchestration engine 30 as separate components, in other examples, the orchestration engine 30 may be combined with the processor 20 and may be part of the same physical component such as a microprocessor configured to carry out multiple functions.

The network interface 15 is to receive a plurality of datasets via a network 100. The network 100 may provide a link to a data source, such as a server managing a database. The network interface 15 may be a wireless network card to communicate with the network 100 via a WiFi connection. In other examples, the network interface 15 may also be a network interface controller connected to via a wired connection such as Ethernet.

The datasets received at the network interface 15 are not particularly limited and may be for applications configured to handle a large amount of data such as to manage a device as a service system. For example, the datasets may be to support an application to operate a device logging system or a device registration system configured to track and record information about multiple devices. Accordingly, each dataset includes metadata associated with the dataset to provide information about how the data in the dataset is to be stored. Other examples where the datasets may be used include complex systems with multiple components where data may be collected from the components. For example, other systems may include an automobile parts logging system, a system to store data about a human body or other biological system as represented in an electronic medical record (EMR), or DNA/RNA if encoded proteins or DNA/RNA segments which contain specific genes which may be considered components.

In the present example, the datasets include generic information that may be used for any application. It is to be appreciated that datasets may be continuously monitored and changed. For example, data may be migrated from one dataset to another dataset, or multiple datasets may be combined into a single dataset. Continuing with the above example of a plurality of datasets for a data application managing a plurality of devices, data in a dataset may be migrated to another dataset in a different database when a physical device ends a subscription with a client and begins a new subscription at another client which is managed by a different server from the original client. In this example, the data stored in the database may include information about the devices being managed in the dataset, such as a device identifier, manufacturing information, or service dates. In other examples, the information may include a model name, device name, warranty information, service information, support information, or system crash information in the device as a service system.

The processor 20 is to determine a variance value associated with the metadata of the datasets received via the network interface. In the present example, the variance value determined by the processor 20 is the percentage variance of selected numerical values in the metadata received. In particular, it is the proportional change of a value. Accordingly, it is to be appreciated that the variance value may be used to indicate the extent to which the datasets received from the multiple sources differ. The processor 20 may include a central processing unit (CPU), a microcontroller, a microprocessor, a processing core, a field-programmable gate array (FPGA), an application-specific integrated circuit (ASIC), or similar. In the present example, the processor 20 may cooperate with a memory storage unit 25 to execute various instructions. For example, the processor 20 may maintain and operate various applications with which a user may interact. In other examples, the processor 20 may send or receive data, such as input and output associated with administering multiple datasets.

The manner by which the processor 20 calculates the variance value is not particularly limited. In the present example, the variance value is determined by joining the metadata received from multiple sources. For example, if the metadata field from different sources store a count of columns in a dataset, the metadata field from each source may be used as the basis for calculating a percentage variance value. It is to be appreciated that the metadata field from the different sources is not particularly limited and may include numerical values that represent other features of the separate datasets.

The memory storage unit 25 is configured to store metadata from received via the network interface 15 as well as the variance value determined by the processor 20. The manner by which the memory storage unit 25 stores the metadata and the variance value is not particularly limited. For example, the memory storage unit 25 may maintain a table in a database to store the metadata received from multiple sources as well as the variance value associated with the metadata that was determined using the processor 20. For example, the table maintained in the memory storage unit 25 may include a separate substructure to store the variance values.

In the present example, the memory storage unit 25 may include a non-transitory machine-readable storage medium that may be, for example, an electronic, magnetic, optical, or other physical storage device. In addition, the memory storage unit 25 may store an operating system that is executable by the processor 20 to provide general functionality to the apparatus 10. For example, the operating system may provide functionality to additional applications. Examples of operating systems include Windows™, macOS™, (OS™, Android™, Linux™, and Unix™. The memory storage unit 25 may additionally store instructions to operate at the driver level as well as other hardware drivers to communicate with other components and peripheral devices of the apparatus 10.

The orchestration engine 30 is to use a variance value stored in the memory storage unit 25 to orchestrate data between the multiple datasets. In the present example, the memory storage unit 25 may allow for fast access of the metadata by the orchestration engine 30 to improve coordination between multiple datasets, such as during a migration or consolidation of datasets. For example, the memory storage unit 25 may arrange the metadata and variance values in a table at a single location. Therefore, the orchestration engine 30 may obtain all the information from this combined location instead of having to retrieve the information from each data source. The variance value may then be used by the orchestration engine 30 to compare portions of the metadata from multiple sources to assess compatibility with each other and/or to test the test the metadata for consistency.

Although the present example shows the orchestration engine 30 and the processor 20 as separate components, in other examples, the orchestration engine 30 and the processor 20 may be part of the same physical component such as a microprocessor configured to carry out multiple functions. In other examples, the orchestration engine 30 and the processor 20 may be on separate servers of a server system connected by a network.

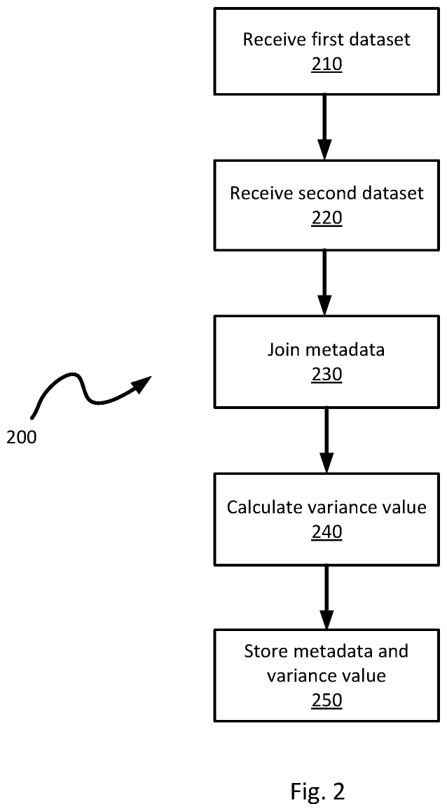

Referring to FIG. 2, a flowchart of an example method to orchestrate data across multiple datasets is generally shown at 200. In order to assist in the explanation of method 200, it will be assumed that method 200 may be performed with the apparatus 10. Indeed, the method 200 may be one way in which apparatus 10 may be configured. Furthermore, the following discussion of method 200 may lead to a further understanding of the apparatus 10 and its various components. In addition, it is to be emphasized, that method 200 may not be performed in the exact sequence as shown, and various blocks may be performed in parallel rather than in sequence, or in a different sequence altogether.

Beginning at block 210, the memory storage unit 25 receives metadata associated with a dataset from a source, such as a database maintained on a remote server, over the network 100 via the network interface 15. The content of the metadata is not limited. In an example, the metadata may represent a dataset used to manage a plurality of devices. Furthermore, the manner by which the metadata is received is not particularly limited. In the present example, the metadata may be received as part of an automated process that is carried out periodically. In other examples, the metadata may be retrieved upon receiving a manual command from a user or administrator. In further examples, the metadata may be collected automatically from other databases, such as databases having an Internet of Things schema, where the devices populate the dataset with various data collected by sensors. In particular, automobiles, both self-driving and not, kitchen appliances, and implanted biological devices such as pacemakers and other RFID-tagged devices may use an Internet of Things schema.

Block 220 involves the memory storage unit 25 receiving additional metadata associated with a dataset from a different source from than the source associated with the metadata received at block 210 over the network 100 via the network interface 15. Similar to the metadata received at block 210, the content of the metadata received from the additional source is not limited. In addition, the manner by which the metadata is received is not particularly limited. In the present example, the metadata may be received as part of an automated process that is carried out periodically. In other examples, the metadata may be retrieved upon receiving a manual command from a user or administrator.

It is to be appreciated that block 210 and block 220 operate to collect multiple datasets from multiple sources. In some examples, more than two datasets may be collected for storage in the memory storage unit 25.

In block 230, the metadata is joined in the memory storage unit 25 by the processor 20 to provide combined metadata. The combined metadata may be stored in a table maintained in the memory storage unit 25. The manner by which the metadata is joined is not particularly limited. For example, the process may involve performing queries on each database to generate the metadata in separate tables, where the tables are subsequently uploaded to single table.

Block 240 involves the processor 20 calculating a variance value based on the combined metadata from block 230. The manner by which the processor 20 calculates the variance value is not particularly limited. In the present example, the variance value is determined by calculating the percentage variance of selected numerical values in the metadata. Continuing with the example above, a query may be carried out on the separate metadata tables from block 230 and the percentage variance may be calculated. In particular, the calculation involves determining a difference between the two numerical values and dividing it by the first value of the metadata in the first table. It is to be appreciated that in the percentage variance value may be positive or negative depending on whether the numerical value in the second table increases or decreases. A positive percentage variance value indicates that the numerical value has increase. In the present example, this may mean that the number of columns in the second dataset is greater than the number of columns in the first dataset. A negative percentage variance value indicates that the numerical value has decreased. In the present example, this may mean that the number of columns in the second dataset is lower than the number of columns in the first dataset. In either situation, the variance value may be used to identify differences as well as characterize differences between two datasets using the metadata of each dataset.

Block 250 stores the combined metadata and the variance value in the memory storage unit 25. The manner by which the combined metadata and the variance value is stored is not limited. In the present example, the memory storage unit 25 may be used to maintain a table in a database for storing the combined metadata and the associated variance value in a searchable format. Furthermore, in some examples, the table may also be divided into a series of metadata which includes a portion of the combined metadata. By focusing on a portion of the metadata, efficiencies may be achieved since the entire metadata may not to be analyzed and evaluated. Furthermore, since the combined metadata and the associated variance value are stored in a single location on the memory storage unit 25, it is to be appreciated that the table may provide a centralized location from which the original datasets at the source may be accessed fast.

The application of the method 200 to provide a memory storage device for orchestrating data from multiple database sources may enhance the performance of various processes, for example, a dataset migration, due to efficiencies that are not possible when separate datasets are located at different sources. For example, the single database on the memory storage unit 25 may be language independent which allows for compatibility with many different programming languages such that the data may be manipulated with the different programming languages.

The method 200 may additionally include orchestrating data between multiple data sources using the orchestration engine 30. In particular, the orchestration engine 30 may use the variance values stored in the memory storage unit 25 to orchestrate the data and validate the data to ensure consistency across multiple datasets which may have different metadata. For example, the variance values may be used to test for differences between the metadata of the various datasets from different sources. In the present example, the testing for differences by the orchestration engine 30 may be carried out automatically. The testing may be carried out automatically after a triggering event, such as a migration or other event.

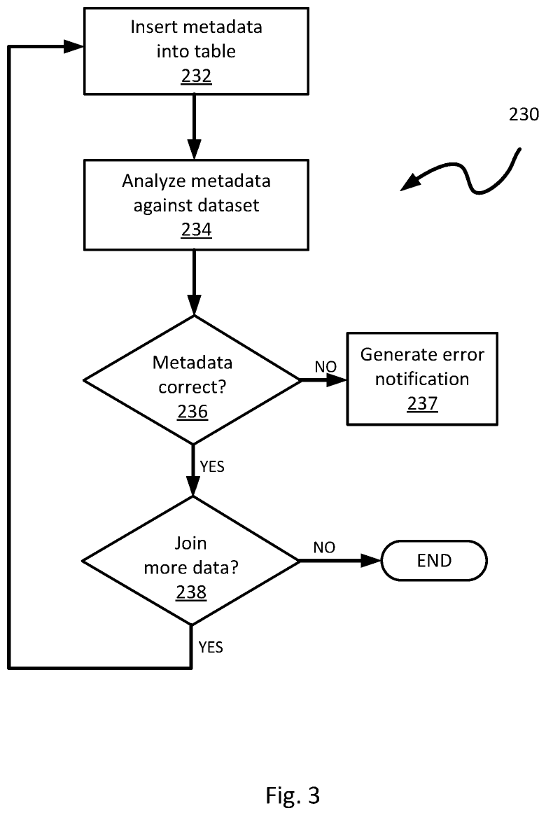

Referring to FIG. 3, a flowchart of an example sub-process of the execution of block 230 to join metadata from multiple sources. In order to assist in the explanation of the execution of block 230, it will be assumed that the execution of block 230 may be performed with the processor 20 subsequent to receiving metadata from multiple sources such as at block 210 and block 220. The following discussion of execution of block 230 may lead to a further understanding of the apparatus 10 and its various components.

In the present example, block 232 inserts the metadata into a table in the memory storage unit 25. The metadata from the multiple sources are added into the table in an appropriate field and the processor 20 verifies that the metadata has been properly inserted. For example, the processor 20 confirms that the correct values are entered based on the design of the table.

Block 234 involve analyzing the metadata in the table against the design of the table. In particular, the metadata is compared with the original metadata received from the source database. Block 236 determines if the metadata in the table is correct. If the metadata is not correct, the process moves to block 237 where a notification of an error is generated. This notification allows a designer of the table to identify and address issues and mistakes in the table at an earlier stage of the design process.

If the determination at block 236 finds no error in the metadata table stored on the memory storage unit 25, the process proceeds to block 238 to determine if additional metadata, such as from another source is to be joined in the table. If more metadata is to be joined, the process returns to block 232. If no further metadata is to be joined, the sub-process ends and returns to carry on method 200.

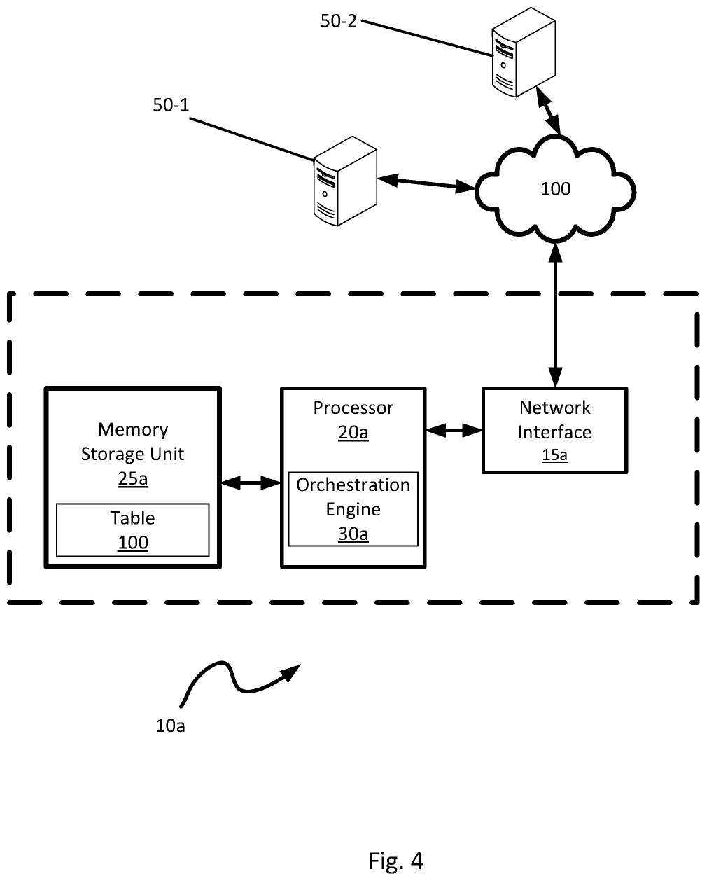

Referring to FIG. 4, another example of an apparatus to orchestrate data with metadata variance data is shown at 10a. Like components of the apparatus 10a bear like reference to their counterparts in the apparatus 10, except followed by the suffix “a”. The apparatus 10a includes a network interface 15a, a processor 20a, a memory storage unit 25a, and an orchestration engine 30a operated by the processor 20a.

In the present example, the apparatus 10a is to operate as part of a device as a service system. In particular, the device as a service system may be an Internet of Things solution, where devices, users, and companies are treated as components in a system that facilitates analytics-driven point of care. In particular, the apparatus 10a may be in communication with other servers 50-1 and 50-2 (generically, these devices are referred to herein as “server 50” and collectively they are referred to as “servers 50”, this nomenclature is used elsewhere in this description). Each of the servers 50 may maintain a database and may be a data source for metadata. Accordingly, the apparatus 10a may be used to orchestrate data between the servers. For example, the apparatus 10a may be used to

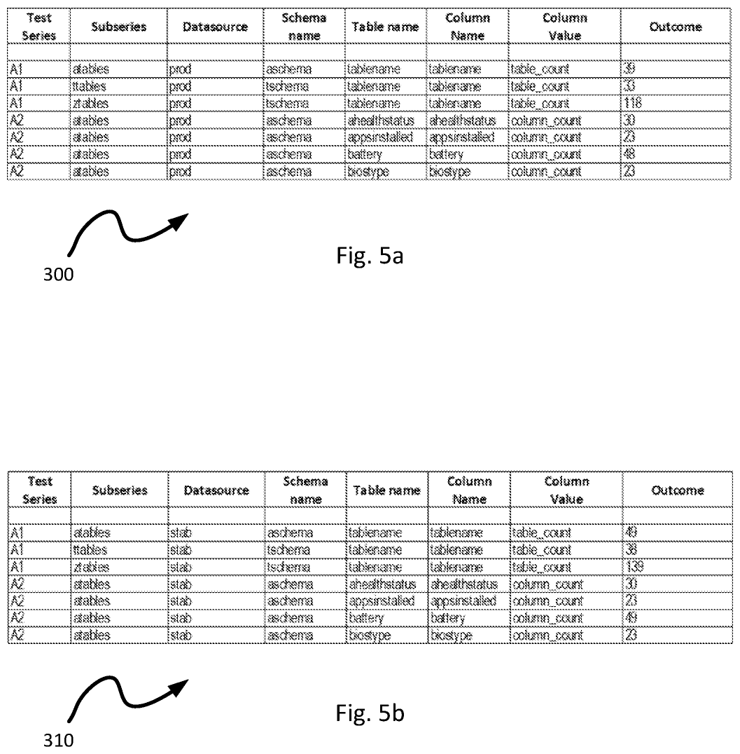

Referring to FIG. 5a, an example of metadata from a dataset is shown generally at 300. FIG. 5b shows an example of metadata from another dataset received from a different source. The following discussion of table 300 and the table 310 may lead to a further understanding of the apparatus 10 as well as the method 200 and their various components. The table includes a plurality of columns to store metadata. In this example, each row of the table 300 may represent a test series for evaluating differences between metadata from one dataset, such as the metadata presented in 300, with metadata from another dataset, such as the metadata presented in 310.

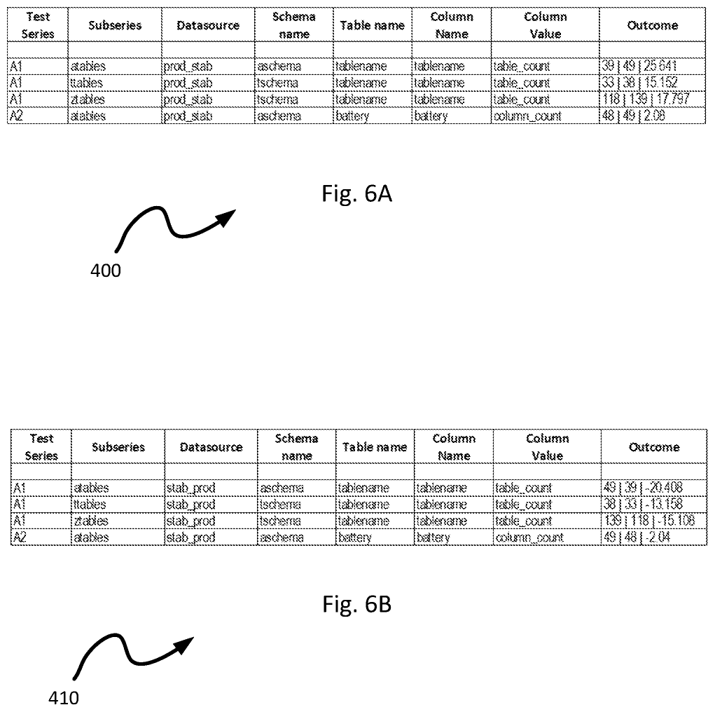

Referring to FIG. 6a, the variance values between the values in table 300 and 310 are calculated and generally shown in the table 400. It is to be appreciated that the generation of the data shown in the table 400 may be the result from the execution of blocks 240 and 250. In particular, the variance value shown in the “outcome” column may be calculated using the following formula:

$$Percentage Variance Value = \frac{( {Value}_{table 310} - {Value}_{table 300} )}{{Value}_{table 300}}$$

After the variance value is calculated, it is to be stored in the memory storage unit 25 in the table 400. This provides a central location from which a designer or administrator may analyze the variance values to determine differences between the metadata from the multiple sources.

Continuing with this example, table 400 illustrates four lines that are different between table 300 and table 310. In particular, the first three lines of the table 400 show that the number of atables, ttables, and ztables are different between two data sources by 25.641%, 15.152%, and 17.797%. The fourth line of table 400 show that the column count in comparable tables between the two data sources differ by 2.08%. Accordingly, this provides an administrator or designer with a way to quantify the differences. For example, if a 20% difference in table numbers between data sources is considered an acceptable tolerance in a data migration, then only the difference associated with atables are to be addressed by an administrator or designer while the remaining variations may be considered acceptable in the data migration exercise.

Referring to FIG. 6b, the variance values between the values in table 310 and 300 are calculated and generally shown in the table 410. It is to be appreciated that the generation of the data shown in the table 410 may be the result from the execution of blocks 240 and 250 on the metadata in the opposite order as from the generation of the results in the table 400. In particular, the variance value shown in the “outcome” column may be calculated using the following formula:

$$Percentage Variance Value = \frac{( {Value}_{table 300} - {Value}_{table 310} )}{{Value}_{table 310}}$$

In this example, the variance values are negative which indicate that the numerical values decreased going from table 310 to table 300. For example, it may be an indication that the number of columns shown in the metadata has decreased which may be caused by columns missing at a dataset. The missing columns may be a result of poor design that is to be corrected. After the variance value is calculated, it is to be stored in the memory storage unit 25 in the table 410. This provides a central location from which a designer or administrator may analyze the variance values to determine differences between the metadata from the multiple sources.

It is to be recognized that features and aspects of the various examples provided above may be combined into further examples that also fall within the scope of the present disclosure.

What is claimed is:

1. An apparatus comprising:
a network interface to receive a first dataset and a second dataset, wherein the first dataset includes first metadata and the second dataset includes second metadata;
a processor to determine a variance value associated with the first metadata and the second metadata;
a memory storage unit to store the first metadata, the second metadata, and the variance value; and
an orchestration engine to use the variance value to orchestrate data between the first dataset and the second dataset.

2. The apparatus of claim 1, wherein the processor determines the variance value by a joining process of the first metadata with the second metadata.

3. The apparatus of claim 1, wherein the memory storage unit maintains a table to store the first metadata, the second metadata, and the variance value.

4. The apparatus of claim 3, wherein the table is accessible by the orchestration engine, the table to provide fast access to the first metadata, the second metadata, and the variance value from a combined location.

5. The apparatus of claim 4, wherein the orchestration engine accesses the table to compare a first portion of the first metadata with a second portion of the second metadata with the variance value.

6. The apparatus of claim 4, wherein the table stores the variance value in a substructure.

7. The apparatus of claim 1, wherein the variance value is to indicate an extent of difference between the first dataset and the second dataset.

8. A method comprising:
receiving a first dataset via a network interface, wherein the first dataset includes first metadata;
receiving a second dataset via the network interface, wherein the second dataset includes second metadata;
joining the first metadata and the second metadata to generate combined metadata;
calculating a variance value based on the combined metadata; and
storing the combined metadata and the variance value in a memory storage unit.

9. The method of claim 8, further comprising orchestrating data between the first dataset and the second dataset.

10. The method of claim 9, wherein orchestrating the data comprises using the variance value to perform the orchestration.

11. The method of claim 10, wherein orchestrating the data comprises testing for differences between the first dataset and the second dataset.

12. The method of claim 8, further comprising maintaining a table to store the combined metadata and the variance value.

13. The method of claim 12, further comprising dividing the table into a series of metadata associated with a portion of the combined metadata.

14. A non-transitory machine-readable storage medium encoded with instructions executable by a processor, the non-transitory machine-readable storage medium comprising:
instructions to collect a plurality of datasets via a network interface from a plurality of sources, wherein each dataset of the plurality of datasets includes metadata;
instructions to join the plurality of datasets to generate combined metadata, wherein the combined metadata includes the metadata from the plurality of datasets stored in a table;
instructions to calculate a variance value in the combined metadata for a field; and
instructions to store the combined metadata and the variance value in the field.

15. The non-transitory machine-readable storage medium of claim 14, further comprising instructions to orchestrate data between the plurality of datasets to test the metadata automatically after a migration.
